(19) United States
(12) Patent Application Publication
(10) Pub. No.: US 2019/0082003 A1
(43) Pub. Date: Mar. 14, 2019

(54) SYSTEM AND METHOD FOR MANAGING DIGITAL SIGNAGE

(71) Applicant: Korea Electronics Technology Institute, Seongnam-si (KR)

(72) Inventors: Jae Won MOON, Seoul (KR); Seung Woo KUM, Yongin-si (KR); Jun Ho JUNG, Seoul (KR)

(21) Appl. No.: 15/893,494

(22) Filed: Feb. 9, 2018

(30) Foreign Application Priority Data
Sep. 8, 2017 (KR) 10-2017-0114922

(51) Int. Cl. H04L 29/08; H04L 29/06; G06F 3/147

(52) U.S. Cl. CPC H04L 67/10; G06Q 30/0277; G06F 3/147; H04L 67/42

(57) ABSTRACT

A system for managing digital signage is disclosed. The system includes a cloud server configured to generate and store signage sets each of which includes content setting information, context information, and event information in the form of a tree. The system also includes a plurality of digital signage servers configured to receive the signage sets, and store and manage the signage sets. The system further includes a plurality of digital signage configured to be provided in groups to each of the digital signage management servers, and receive content included in the signage sets from the digital signage management servers and output the content on the basis of the content setting information. The digital signage management servers receive characteristic information of a user in real time and transmit the content setting information and the content corresponding to the user's characteristic information to a corresponding digital sign.

### CROSS-REFERENCE TO RELATED APPLICATION

This application claims priority to and the benefit of Korean Patent Application No. 10-2017-0114922, filed on Sep. 8, 2017, the disclosure of which is incorporated herein by reference in its entirety.

### BACKGROUND

### 1. Field

The described technology generally relates to a system and method for managing digital signage.

### 2. Discussion of Related Art

Digital signage is a device that provides a variety of information and advertising messages in an interactive manner in a public or commercial space. The digital signage refers to an information medium that incorporates various IT technologies into a display which provides conventional digital information.

The digital signage is installed in the form of a digital display which can be remotely controlled via a network in a public space or a commercial space, and provides information beyond conventional outdoor advertising.

Meanwhile, most advertisements provided through existing digital signage are provided as content images through unilateral setting by service providers.

In the case of an advertisement utilizing a conventional digital sign, a context is fixed with respect to hardware and specific content is exposed in accordance with context predetermined between a user sensor and a display device. Accordingly, it is difficult to freely expand the context and changing the content is complicated.

Thus, there is a need for a technology for expanding an advertisement in digital signage, which has been conventionally provided with a focus on hardware, with a software-centric approach, thereby making it possible to freely change a context and content of the advertisement.

In this regard, Korean Patent Laid-Open Publication No. 10-2015-0139767 (titled “Digital Signage System by Nearfield User Identification”) discloses a technology in which a user located near a digital information display (DID) is identified and customized content is provided to the identified user.

### SUMMARY

Embodiments of the present invention provide a system and method for managing digital signage, which can provide interactive content to a number of unspecified users or membership users in consideration of context information and event information.

The technical objects of the present invention are not limited to the aforementioned objects, and other technical objects should be obvious to those skilled in the art from the following description.

In one general aspect, there is provided a system for managing digital signage, including: a cloud server configured to generate and store signage sets which each include content setting information obtained by processing content, context information, and event information in the form of a tree; a plurality of digital signage servers configured to receive the signage set from the cloud server and store and manage the signage set; and a plurality of digital signage configured to be provided in groups to each of the plurality of digital signage management servers and receive content included in the signage set from the digital signage management servers and output the content on the basis of the content setting information, wherein the plurality of digital signage management servers receive characteristic information of a user in real time and transmit the content setting information and the content corresponding to the user's characteristic information among the signage set to a corresponding digital sign.

The system may further include: a sensor device configured to sense interaction information of the user; and a characteristic information analysis server configured to analyze the sensed interaction information to extract the characteristic information of the user and transmit the extracted user's characteristic information to the digital signage management servers.

When the characteristic information analysis server receives the user's interaction information, the characteristic information analysis server may assign an identity (ID) to the corresponding user, analyze a sex and age of the user to which the ID is assigned, and extract the sex and age as the user's characteristic information together with the interaction information.

The number of the plurality of digital signage may match the number of sensor devices or be different from the number of sensor devices, and the sensor devices may be included in the digital signage or installed in a separate place.

The digital signage management servers may track whether the user moves out of a sensing range of the sensor device while the digital signage are outputting the content corresponding to the user's characteristic information, and when sensing of the user's interaction information is interrupted as the user moves out of the sensing range, the digital signage management servers may output content corresponding to content setting information that corresponds to the user's characteristic information until the content ends.

When the user moves out of the sensing range but interaction information of another user is sensed by the sensor device, the digital signage management servers may stop outputting the content, extract characteristic information corresponding to interaction information of the other user, and transmit content setting information and content corresponding to the extracted characteristic information to the corresponding digital signage.

When the digital signage management servers fail to receive the user's characteristic information, the digital signage management servers may control the digital signage to output content set to be reproduced by default among pieces of content included in the signage set.

The signage sets may be generated separately according to time and stored, and the digital signage management servers may extract a signage set corresponding to a time of interest and control the digital signage to output content corresponding to characteristic information of the user among content setting information included in the extracted signage set.

The cloud server may include a signage set generation program for generating the signage sets and the signage set generation program may add content setting information selected by an administrator to area in which the signage sets is generated and generate a signage set as content corresponding to the content setting information is dragged and dropped therein.

The content may include tag information used to expand the signage set, and the signage set generation program may recommend content having a predetermined similarity to tag information included in content selected by the administrator and provides the recommended content to the administrator.

The cloud server may include information used for managing the plurality of digital signage management servers and the digital signage provided in groups to each of the plurality of digital signage management servers.

In another general aspect, there is provided a method of managing digital signage, including: generating and storing, by a cloud server, signage sets which each include content setting information obtained by processing content, context information, and event information in the form of a tree; transmitting the generated signage set to a plurality of corresponding signage management servers; providing characteristic information of a user to the plurality of digital signage management servers in real time; transmitting, by the plurality of digital signage management servers, the content setting information and the content corresponding to the user's characteristic information among the signage set to corresponding digital signage; and outputting, by the digital sign, the content on the basis of the content setting information, wherein the digital signage are managed in groups by each of the plurality of digital signage management servers.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings.

FIG. 1 is a diagram for schematically describing a digital signage management system 1 according to one embodiment of the present invention.

FIG. 2 is a block diagram for describing the digital signage management system 1 according to one embodiment of the present invention.

FIGS. 3A, 3B and 3C are diagrams for describing a relationship between sensor devices and digital signage.

FIG. 4 is a block diagram for describing a signage set generation program.

FIG. 5 is a diagram illustrating an example of the signage set generation program.

FIG. 6 is a diagram for describing a signage set.

FIG. 7 is a flowchart illustrating a method for managing digital signage according to one embodiment of the present invention.

### DETAILED DESCRIPTION

Embodiments will be described more fully hereinafter with reference to the accompanying drawings. However, the present invention may be embodied in many different forms and is not to be construed as being limited to the embodiments set forth herein. Also, irrelevant details have been omitted from the drawings for increased clarity and conciseness.

Throughout the detailed description, unless explicitly described to the contrary, the word “comprise” and variations such as “comprises” or “comprising” should be understood to imply the inclusion of stated elements and not the exclusion of any other elements.

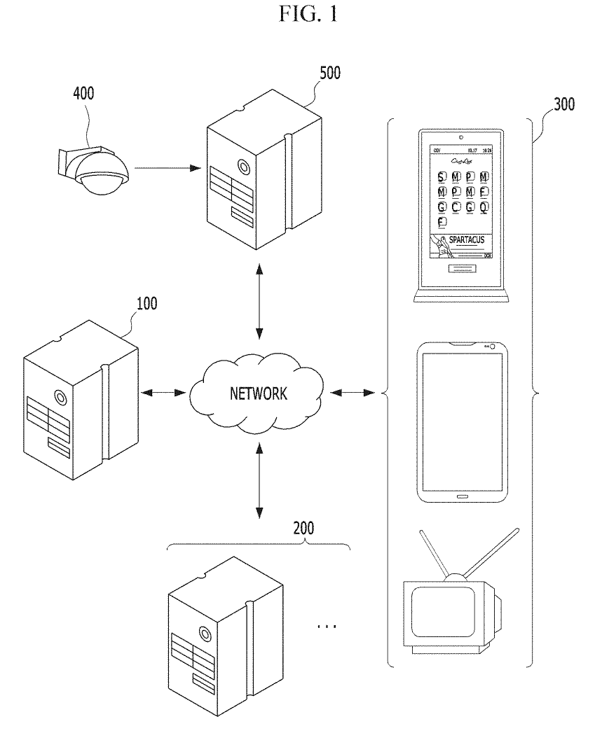

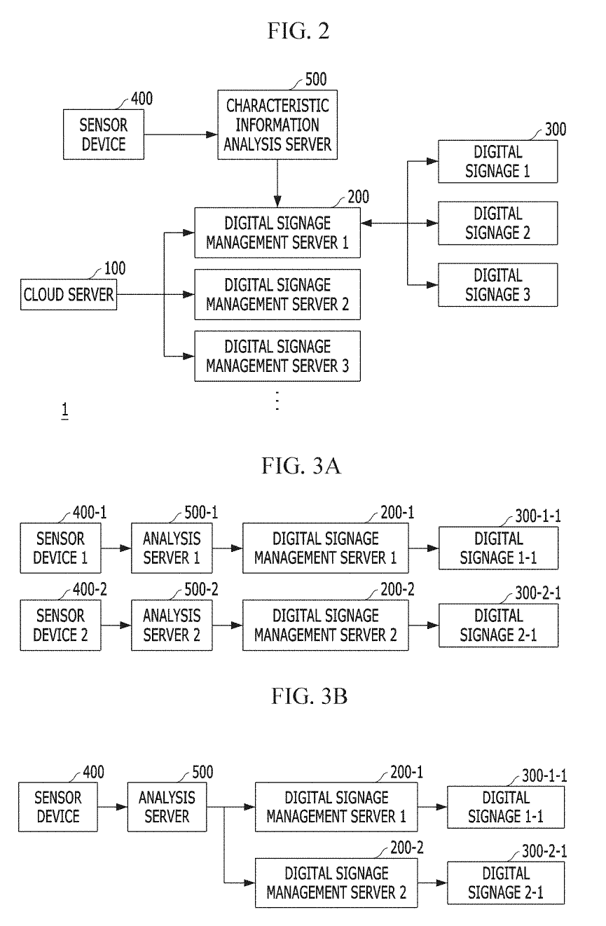

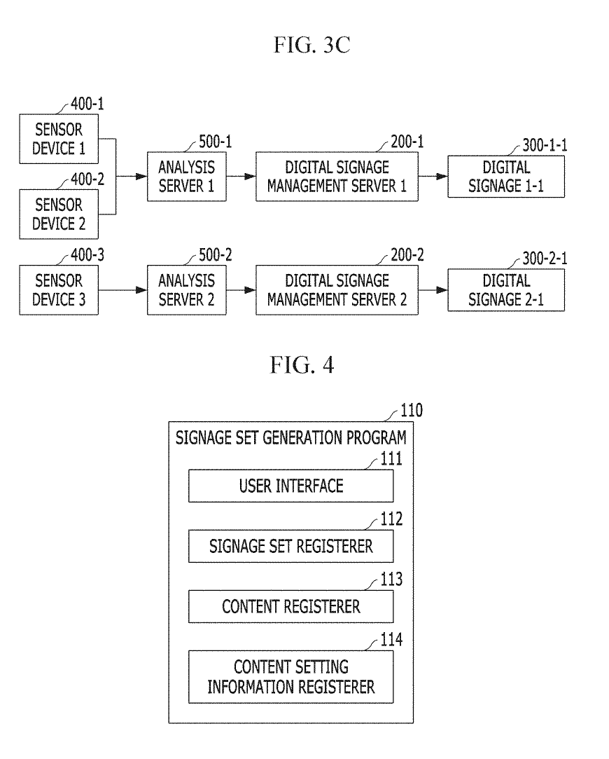

FIG. 1 is a diagram for schematically describing a digital signage management system 1 according to one embodiment of the present invention. FIG. 2 is a block diagram for describing the digital signage management system 1 according to one embodiment of the present invention. FIGS. 3A to 3C are diagrams for describing a relationship between sensor devices 400 and digital signage 300.

The digital signage management system 1 according to one embodiment of the present invention includes a cloud server 100, digital signage management servers 200, the digital signage 300, a sensor device 400, and a characteristic information analysis server 500.

In this case, one embodiment of the present invention is characterized in that the digital signage management servers 200, the digital signage 300, the sensor device 400, and the characteristic information analysis server 500 are installed and disposed in a fixed environment in advance, wherein, unlike a conventional case in which hardware and software of the digital sign 300 are provided in the form of an integrated package, a signage set is processed and provided by the cloud server 100, thereby allowing content appropriate to a situation to be output.

Meanwhile, the components constituting the digital signage management system 1 shown in FIG. 1 may be connected to each other through a network. The network refers to a connection structure which allows information exchange between nodes, such as terminals and servers. Examples of the network may include a 3^{rd} generation partnership project (3GPP) network, a long term evolution (LTE) network, a world interoperability for microwave access (WIMAX) network, the Internet, a local area network (LAN), a wireless LAN, a wide area network (WAN), a personal area network (PAN), a Bluetooth network, a satellite broadcasting network, an analog broadcasting network, a digital multimedia broadcasting (DMB) network, Wi-Fi, and the like, but are not limited thereto.

Referring to FIGS. 1 and 2, the cloud server 100 is configured to set related information so that the digital signage 300 can reproduce content according to context information and event information.

To this end, the cloud server 100 stores content to be output through the digital signage 300 and content setting information obtained by processing context information and event information corresponding to the content in the form of a tree. In this case, in one embodiment of the present invention, the content and the corresponding content setting information are referred to as a signage set, and the cloud server 100 generates and stores the signage set.

In addition, the cloud server 100 stores information used for managing a plurality of digital signage management servers 200 and digital signage 300, which are provided in groups to each of the digital signage management servers 200.

The plurality of digital signage management servers 200 are connected to the cloud server 100 to receive, store, and manage the signage set.

The digital signage 300 are provided in groups to each of the plurality of digital signage management servers 200. For example, a first digital signage management server may be provided with three digital signage, and a second digital signage management server may be provided with only one digital sign.

Each of the digital signage 300 receives the content and the content setting information corresponding to the content included in the signage set from the digital signage management server 200 which manages the group to which the digital sign 300 belongs. In addition, the digital sign 300 outputs the content according to the content setting information.

Each of the digital signage 300 according to one embodiment of the present invention may be a digital sign, such as a digital information display or a touchscreen kiosk installed in a specific place, and may be a notebook computer equipped with a web browser, a desktop computer, a laptop computer, and a mobile phone, a smart pad, a smart watch, a wearable terminal, or other mobile communication terminals, which are intelligent terminals to which computer support functions, such as an Internet communication and information search, are added and in which a plurality of applications desired by a user can be installed and executed, a smart phone.

The sensor device 400 senses interaction information of the user. Examples of the sensor device 400 may include various sensors, such as a motion sensor, a vision sensing-based sensor, an Internet protocol (IP) camera, and a microphone, for sensing an interaction of the user.

The characteristic information analysis server 500 analyzes the interaction information sensed by the sensor device 400, extracts characteristic information of the user, and transmits the extracted characteristic information to the digital signage management servers 200.

In this case, when the characteristic information analysis server 500 receives the user's interaction information, the characteristic information analysis server 500 assigns an identity (ID) to the corresponding user and extracts user's characteristic information along with the interaction information by analyzing the sex and age of the user to which the ID is assigned.

Meanwhile, when a sensing range of the sensor device 400 for the user's interaction information is below a preset threshold, the characteristic information analysis server 500 may not extract the user's characteristic information. For example, in the case in which the sensor device 400 is a camera, when a user occupies an area of less than 30% of a total area of an entire image on a screen, it is determined that interaction information of the user is not sufficiently collected, and thus characteristic information may not be extracted.

The plurality of digital signage management server 200 receive the user's characteristic information in real time to be capable of transmitting content setting information and content corresponding to the user's characteristic information among the signage set to the digital signage 300.

The number of sensor devices 400 may match the number of digital signage 300 or be different from the number of the digital signage 300. The sensor devices 400 may be included in the digital signage 300 or installed in a separate place. For example, when a camera and a microphone are the sensor devices 400, like a general digital sign 300, the camera and the microphone may be included in the digital sign 300.

That is, as shown in FIG. 3A, as the digital sign 300, the sensor device 400, and the analysis server 500 are provided in a one-to-one relationship, a digital signage management server 1 200-1 may receive interaction information and characteristic information of a user through a sensor device 1 400-1 and an analysis server 1 500-1 and provide content setting information and content corresponding to the received information to a digital sign 1-1 300-1-1 by analyzing the received information. Similarly, a digital signage management server 2 200-2 may receive interaction information and characteristic information of the user through a sensor device 2 400-2 and an analysis server 2 500-2 and provide content setting information and content corresponding to the received information to digital sign 2-1 300-2-1 by analyzing the received information.

In addition, according to one embodiment of the present invention, the digital signage 300 and the sensor devices 400 may be installed in a separate place, and interaction information of the user sensed by one sensor device 400 may be utilized for the plurality of digital signage 300.

For example, as shown in FIG. 3B, the analysis server 500 collects interaction information of a user sensed by a sensor device 400 disposed at a first floor entry and transmits characteristic information of the user to the digital signage management server 1 200-1 and the digital signage management server 2 200-2, and each of the digital signage management servers 1 and 2 200-1 and 200-2 may provide content setting information and content to the digital signage 1 300-1-1 disposed on the second floor and the digital signage 2 300-2-1 disposed in the basement, which are managed by the digital signage management servers 200-1 and 200-2, respectively, so that the content setting information and the content can be output.

In another example, as shown in FIG. 3C, interaction information of a user sensed by the plurality of sensor devices 400-1 and 400-2 disposed at various places may be provided to the analysis server 1 500-1, and the analysis server 1 500-1 may extract characteristic information of the user and provide the user's characteristic information to the digital signage management server 1 200-1. Accordingly, the digital signage management server 1 200-1 may provide content setting information and content to the digital signage 101 300-1-1 managed by the digital signage management server 1 200-1 to output the content setting information and the content.

Meanwhile, the cloud server 100 in one embodiment of the present invention includes a signage set generation program 110 for generating a signage set, which will be described with reference to FIGS. 4 to 6.

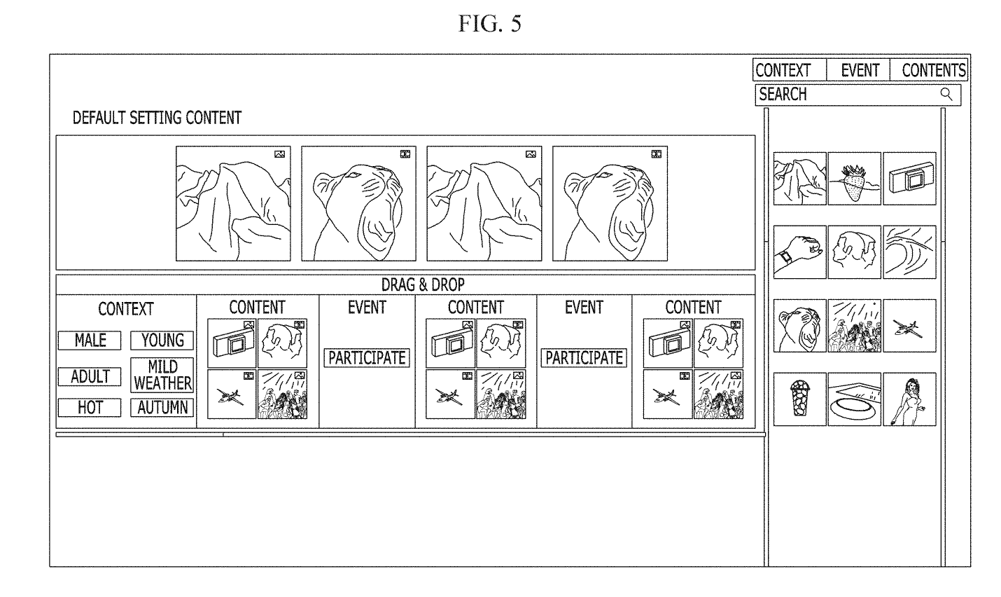

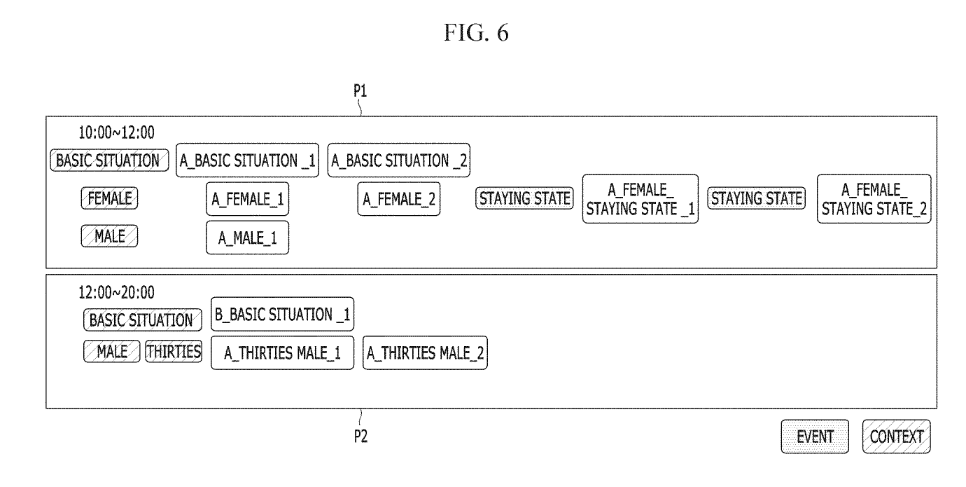

FIG. 4 is a block diagram for describing the signage set generation program 110. FIG. 5 is a diagram illustrating an example of the signage set generation program 110. FIG. 6 is a diagram for describing a signage set.

Referring to FIGS. 4 and 5, the signage set generation program 110 may include a user interface 111, a signage set registerer 112, a content registerer 113, and a content setting information registerer 114.

The signage set generation program 110 may allow a signage set to be generated and managed by reflecting information about digital sign 300 belonging to a particular digital signage management server among the plurality of digital signage management servers 200 through the user interface 111.

The signage set registerer 112 is configured to generate a signage set and to add content setting information selected by an administrator and generate a signage set as content corresponding to the content setting information is dragged and dropped therein. Accordingly, the administrator may modify the content and content setting information to a desired style and provide the modified content and content setting information.

In addition, the signage set registerer 112 may generate signage sets separately according to time as described below with reference to FIG. 6.

The administrator may register the content through the content registerer 113. In this case, the content may include all of videos, images, sounds, and the like, and content of an external content provider may be used or content provided through internal authoring may be registered. Accordingly, easy and highly scalable authoring of advertisement to be provided to the digital signage 300 can be expected.

In this case, the content registerer 113 may assign tag information to each piece of content to expand the signage set at a time at which content is registered. As a result, when the administrator selects the content through a drag-and-drop operation or the like, content having a predetermined similarity to the tag information included in the content may be added and provided to the administrator.

For example, in the case of content corresponding to “mountain” among pieces of content of FIG. 5, tags, such as “#Trip,” “#Camping,” and “#Climbing,” are set and registered along with the content, and it is recommended that content having the same or similar tag based on a similarity there to be registered as well at the time at which the content is registered.

Therefore, one embodiment of the present invention is advantageous in that it is possible to automatically recommend content without a large amount of content being searched directly by the administrator, thereby enhancing convenience when generating a signage set.

In addition, the administrator may register default setting content through the content registerer 113. The default setting content is registered and generated as a signage set so that the digital signage management server 200 may control the digital sign 300 to output the basic setting content, which is set to be reproduced by default among the content included in the signage set, when the digital signage management server 200 fails to receive user characteristic information.

The content setting information registerer 114 registers context information and event information. In this case, the context information may be sex (male/female), age (child/youth/adult/elderly), weather (sunny/rainy/snowy/cloudy/null), season (spring/summer/autumn/winter), temperature (hot/warm/cool/cold/null), and the like. The event information is a sensing range of the sensor device 400, and may be staying, participating, away, and the like. That is, the context information may be information that does not change in real time in relation to the user or external environment information, and the event information may be information that changes over time in association with the user. According to one embodiment of the present invention, it is possible to provide content synchronously with the context information and the event information. Signage sets P1 and P2 may be generated separately according to time and stored as shown in FIG. 6. Accordingly, the digital signage management server 200 may extract the signage sets P1 and P2 corresponding to a time of interest and control the digital sign 300 to output content corresponding to characteristic information of the user among content setting information included in the extracted signage sets P1 and P2.

For example, in FIG. 6, the signage set 1 P1 is generated to have a time range from 10:00 to 12:00 and is stored, and the signage set 2 P2 is generated to have a time range from 12:00 to 20:00 and include different context information from that of the signage set 1 P1 and is stored.

Therefore, the digital signage management server 200 may extract the signage set 1 P1 for the time period from 10:00 to 12:00 and the signage set 2 P2 for the time period from 12:00 to 20:00, and output content corresponding to characteristic information of the user through the digital sign 300.

More specifically, the signage set 1 P1 includes “basic situation,” “female,” and “male” as context information, and includes “staying state” as event information. Here, in the signage set 1 P1, as described above, the context information and the event information are processed and stored in the form of a tree.

In the case of a “basic situation” in which characteristic information about “male” or “female” fails to be received, when characteristic information transmitted as interaction information of “female” is sensed at 11:00 a.m. while A_basic_situation1 and A_basic_situation 2, which are pieces of content corresponding to the “basic situation,” are being reproduced randomly or according to priority order, content corresponding to A_female_1 or A_female_2 is output through the digital sign 300.

Then, when the “female” leaves a site and is no longer provided with the interaction information, the content corresponding to the “basic situation” is output, and when the “female” satisfies the “staying state” as the event information, A_female_staying_1 content is output through the digital sign 300.

Meanwhile, the digital signage management server 200 may track whether the user is out of the sensing range of the sensor device 400 while the digital sign 300 is outputting the content corresponding to the characteristic information.

Thus, when sensing of the user's interaction information is interrupted as the user moves out of the sensing range, the digital signage management server 200 may control the digital sign 300 to output content corresponding to content setting information that corresponds to the user's characteristic information until the content ends.

In addition, when the user moves out of the sensing range but interaction information of another user is sensed by the sensor device 400 while the same content is being output, the digital signage management server 200 may stop outputting the currently output content, extract characteristic information corresponding to the interaction information of the other user, and transmit content setting information and content corresponding to the characteristic information to the corresponding digital sign 300.

The cloud server 100, the digital signage management servers 200, the digital signage 300, and the characteristic information analysis server 500 according to one embodiment of the present invention may be configured to include a communication module (not shown), a memory (not shown), and a processor (not shown).

Here, the communication module may include both a wired communication module and a wireless communication module. The wired communication module may be implemented as a power line communication device, a telephone line communication device, a cable home (MoCA) device, Ethernet, IEEE 1294, an integrated wired home network, and an RS-485 control device. In addition, the wireless communication module may be implemented with the above described UNB, WLAN, Bluetooth, high data rate (HDR) WPAN, UWB, ZigBee, impulse radio, 60-GHz WPAN, binary-code division multiple access (CDMA), wireless USB technology, wireless high definition multimedia interface (HDMI) technology, and the like.

In addition, the memory collectively refers to a non-volatile storage device which retains stored information even when power is not supplied thereto and a volatile storage device. For example, the memory may include a NAND flash memory, such as a compact flash (CF) card, a secure digital (SD) card, a memory stick, a solid-state drive (SSD), and a micro SD card, a magnetic computer memory device, such as a hard disk drive (HDD), and an optical disc drive, such as a compact disc read-only memory (CD-ROM), a digital versatile disc (DVD)-ROM, and the like.

For reference, the components shown in FIG. 2 according to one embodiment of the present invention may be realized in the form of a software component or a hardware component such as a field programmable gate array (FPGA) or an application specific integrated circuit (ASIC), and may perform predetermined roles.

However, the “components” are not limited to software or hardware components, and each of the components may be configured to reside on an addressable storage medium and be executed by one or more processors.

Thus, a component unit may include, by way of example, a component such as a software component, an object-oriented software component, a class component, a task component, a process, a function, an attribute, a procedure, a subroutine, a segment of a program code, a driver, firmware, a microcode, circuitry, data, a database, a data structure, a table, an array, and a variable.

The components and functionality provided by the components may be combined into fewer components or further separated into additional components.

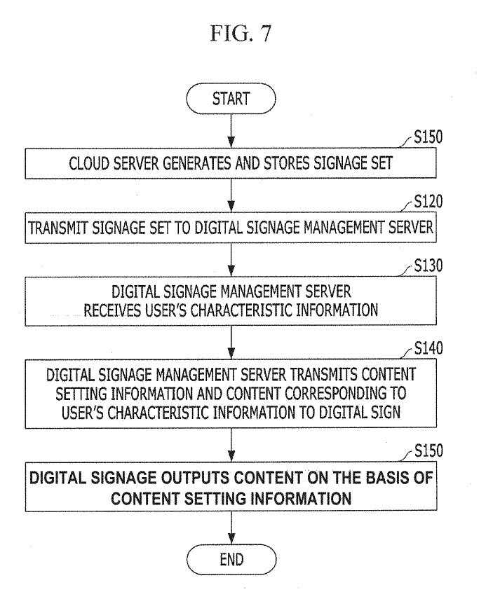

Hereinafter, a method of managing digital signage performed by the digital signage management system 1 according to one embodiment of the present invention will be described with reference to FIG. 7.

FIG. 7 is a flowchart illustrating a method for managing digital signage according to one embodiment of the present invention.

First, the cloud server 100 generates and stores a signage set including content setting information obtained by processing content, context information, and event information in the form of a tree (S110).

Then, the cloud server 100 transmits the generated signage set to a plurality of corresponding digital signage management servers 200 (S120).

Then, the digital signage management servers 200 are provided with characteristic information of a user from the characteristic information analysis server 500 in real time (S130). In this case, when the characteristic information analysis server 500 receives user's interaction information sensed by the sensor device 400, the characteristic information analysis server 500 may extract characteristic information of the user by analyzing the interaction information.

Ten, the digital signage management servers 200 transmit content setting information and content corresponding to the user's characteristic information among the signage set to corresponding digital signage 300 (S140). In this case, the digital signage 300 are managed in groups by each of the plurality of digital signage management servers 200.

Accordingly, the digital signage 300 output content on the basis of the content setting information (S150).

Meanwhile, in the above description, operations S110 to S150 may be combined into fewer operations or further divided into more operations according to an embodiment of the present invention. In addition, some of the operations may be omitted or performed in a different order. Furthermore, the description provided for the digital signage management system 1 with reference to FIGS. 1 to 6 is applicable to the method of managing digital signage of FIG. 7 even though it has been omitted.

According to one embodiment of the present invention, the signage set including the content and the content setting information is generated and stored in a side of the cloud server 100, and the signage set is distributed to the digital signage management servers 200 so that a context can be changed in real time and an interactive event response is possible.

In addition, it is possible to consider a change flow of the content so that an authoring tool allowing a non-expert to author content for each of the digital signage 300 can be provided.

Moreover, the content may be provided through external authoring in the cloud or may be internally provided through the signage set generation program 110.

Particularly, differences between one embodiment of the present invention and a conventional art are as follows.

First, in the conventional art, design and interactive content provision are managed in the form of an integrated set so that the authoring and provision of content are not possible without relevant technical knowledge, and in the case of an interactive sign, utilization thereof has been very low since the interactive sign was developed in the form in which hardware and content are integrated.

By contrast, one embodiment of the present invention has advantages in that content and the configuration of the digital signage 300 are independently separated, various third parties can easily participate, and external resources are also readily available. In addition, service providers who do not have background knowledge about the present technical field can easily create context-based content by a simple drag-and-drop operation. Further, content reflecting a user interaction may be expanded to various digital signage 300 and be displayed.

Second, in the conventional art, consideration of various contexts is insufficient. Also, a recently developed interactive digital sign 300 has a problem in that software and hardware are developed in an integrated package form, and thus it is difficult to use the hardware and software separately or apply them to an existing digital sign.

By contrast, one embodiment of the present invention has advantages in that various results regarding images, real-time Internet of Things (IoT), data analysis results, sensor events, and the like can be used as contexts and the use of the signage set generation program 110 enables a context appropriate to a situation to be flexibly modified and utilized. Also, content may be easily distributed and managed through the cloud server 100 and context management for each of the digital signage 300 may be easily performed.

According to one of embodiments of the present invention, a signage set including content and content setting information is generated and stored in a cloud server side, and the signage set is distributed to a plurality of digital signage management servers so that it is possible to change a context in real time and perform an interactive event response.

In addition, it is possible to consider a change flow of the content so that an authoring tool allowing a non-expert to author content for each digital sign can be provided.

Further, the content may be provided through external authoring in the cloud or may be internally provided through a signage set generation program.

One embodiment of the present invention may be implemented in the form of a computer program stored in a medium executed by a computer or a recording medium that includes computer executable instructions. The computer-readable medium may be any usable medium that can be accessed by a computer, and may include all volatile and nonvolatile media and detachable and non-detachable media. Also, the computer-readable medium may include all computer storage media and communication media. The computer storage medium includes all volatile and nonvolatile media and detachable and non-detachable media implemented by a certain method or technology for storing information such as computer-readable instructions, data structures, program modules, or other data. The communication medium typically includes computer-readable instructions, data structures, program modules, other data of a modulated data signal such as a carrier wave, or other transmission mechanisms, and includes information transmission media.

The method and system of the present invention have been described in connection with specific embodiments of the invention, and some or all of the components or operations thereof may be realized using a computer system that has general-use hardware architecture.

The above description of the invention is for illustrative purposes, and a person having ordinary skilled in the art should appreciate that specific modifications can be easily made thereto without departing from the technical spirit or essential features of the invention. Therefore, the foregoing embodiments should be regarded as illustrative rather than limiting in all aspects. For example, each component described as being of a single type can be implemented in a distributed manner. Likewise, components described as being distributed can be implemented in a combined manner.

The scope of the present invention is not defined by the detailed description set forth above but by the accompanying claims of the invention. It should also be understood that all changes or modifications derived from the definitions and scopes of the claims and their equivalents fall within the scope of the invention.

What is claimed is:

1. A system for managing digital signage, comprising:
a cloud server configured to generate and store signage sets each of which includes content setting information obtained by processing content, context information, and event information in the form of a tree;
a plurality of digital signage servers configured to receive the signage sets from the cloud server and store and manage the signage sets; and
a plurality of digital signage configured to be provided in groups to each of the plurality of digital signage management servers and receive content included in the signage sets from the digital signage management servers and output the content on the basis of the content setting information,
wherein the plurality of digital signage management servers receive characteristic information of a user in real time and transmit the content setting information and the content corresponding to the user's characteristic information among the signage sets to a corresponding digital sign.

2. The system of claim 1, further comprising:
a sensor device configured to sense interaction information of the user; and
a characteristic information analysis server configured to analyze the sensed interaction information to extract the characteristic information of the user and transmit the extracted user's characteristic information to the digital signage management servers.

3. The system of claim 2, wherein, when the characteristic information analysis server receives the user's interaction information, the characteristic information analysis server is configured to assign an identity (ID) to the corresponding user, analyze a sex and age of the user to which the ID is assigned, and extract the sex and age as the user's characteristic information together with the interaction information.

4. The system of claim 2, wherein the number of the plurality of digital signage matches the number of sensor devices or is different from the number of sensor devices, and the sensor devices are included in the digital signage or installed in a separate place.

5. The system of claim 2, wherein the digital signage management servers are configured to track whether the user moves out of a sensing range of the sensor device while the digital signage are outputting the content corresponding to the user's characteristic information, and when sensing of the user's interaction information is interrupted as the user moves out of the sensing range, the digital signage management servers are configured to output content corresponding to content setting information that corresponds to the user's characteristic information until the content ends.

6. The system of claim 5, wherein, when the user moves out of the sensing range but interaction information of another user is sensed by the sensor device, the digital signage management servers are configured to stop outputting the content, extract characteristic information corresponding to interaction information of the other user, and transmit content setting information and content corresponding to the extracted characteristic information to a corresponding digital sign.

7. The system of claim 1, wherein, when the digital signage management servers fail to receive the user's characteristic information, the digital signage management servers are configured to control the digital signage to output content set to be reproduced by default among pieces of content included in the signage sets.

8. The system of claim 1, wherein the signage sets are generated separately according to time and stored, and the digital signage management servers are configured to extract a signage set corresponding to a time of interest and control the digital signage to output content corresponding to characteristic information of the user among content setting information included in the extracted signage set.

9. The system of claim 1, wherein the cloud server includes a signage set generation program for generating the signage sets, and the signage set generation program is configured to add content setting information selected by an administrator to area in which the signage sets are generated and generate a signage set as content corresponding to the content setting information is dragged and dropped therein.

10. The system of claim 9, wherein the content includes tag information used to expand the signage sets, and the signage set generation program are configured to recommend content having a predetermined similarity to tag information included in content selected by the administrator and provide the recommended content to the administrator.

11. The system of claim 1, wherein the cloud server includes information used for managing the plurality of digital signage management servers and the digital signage provided in groups to each of the plurality of digital signage management servers.

12. A method of managing digital signage, comprising:
generating and storing, by a cloud server, signage sets each of which includes content setting information obtained by processing content, context information, and event information in the form of a tree;
transmitting the generated signage sets to a plurality of corresponding signage management servers;
providing characteristic information of a user to the plurality of digital signage management servers in real time;
transmitting, by the plurality of digital signage management servers, the content setting information and the content corresponding to the user's characteristic information among the signage sets to corresponding digital signage; and
outputting, by the digital sign, the content on the basis of the content setting information,
wherein the digital signage are managed in groups by each of the plurality of digital signage management servers.
